(19) United States
(12) Patent Application Publication
(10) Pub. No.: US 2025/0180744 A1
(43) Pub. Date: Jun. 5, 2025

(54) ADAPTIVE LIDAR SCANNING TECHNIQUES FOR IMPROVED FRAME RATE AND SAFETY

(71) Applicants: Christopher Bessette, Cambridge, MA (US); Steven J. Byrnes, Cambrdige, MA (US); Michael G. Moebius, Cambridge, MA (US); Scott Evan Lennox, Cambridge, MA (US); Steven J. Spector, Cambridge, MA (US)

(72) Inventors: Christopher Bessette, Cambridge, MA (US); Steven J. Byrnes, Cambrdige, MA (US); Michael G. Moebius, Cambridge, MA (US); Scott Evan Lennox, Cambridge, MA (US); Steven J. Spector, Cambridge, MA (US)

(73) Assignee: The Charles Stark Draper Laboratories, Inc., Cambridge, MA (US)

(21) Appl. No.: 18/795,594

(22) Filed: Aug. 6, 2024

Related U.S. Application Data
(63) Continuation of application No. 16/664,411, filed on Oct. 25, 2019, now Pat. No. 12,055,631.
Application No. 16/664,411 is a continuation of application No. 62/751,497, filed on Oct. 26, 2018.
(60) Provisional application No. 62/751,500, filed on Oct. 26, 2018.

(51) Int. Cl. G01S 17/89; G01S 7/499; G01S 13/86; G01S 17/26; G01S 17/93; H01S 3/13

(52) U.S. Cl. CPC G01S 17/89; G01S 7/499; G01S 13/865; G01S 13/867; G01S 17/26; G01S 17/93; H01S 3/1305

(57) ABSTRACT

A LIDAR system includes an array of optical emitters, an objective lens optically coupling each optical emitter to a respective unique portion of a field of view, an optical switching network coupled between a laser and the array of optical emitters and a controller coupled to the optical switching network and configured to cause the optical switching network to route light from the laser to a sequence of the optical emitters according to a dynamically varying temporal pattern and to vary the temporal pattern based at least in part on distance to an object within the field of view. The LiDAR system scans different portions of the field of view differently, such as with different laser power levels, different revisit rates and/or different scan patterns, for example based on likelihood of detecting objects of interest in the various portions or based on likely relative importance of objects likely to be found in the various portions.

### CROSS REFERENCE TO RELATED APPLICATIONS

This application claims the benefit of U.S. Provisional Patent Application No. 62/751,497, filed Oct. 26, 2018, titled “Beam Scanning Methods for Improved Eye Safety in LIDAR Systems,” and U.S. Provisional Patent Application No. 62/751,500, filed Oct. 26, 2018, titled “Adaptive LiDAR Scanning Techniques for Improved Frame Rate And Safety,” the entire contents of each of which are hereby incorporated by reference herein, for all purposes. The present application is related to U.S. patent application Ser. No. 16/663,814, titled “Beam Scanning Methods for Improved Eye Safety in LiDAR Systems,” practitioner's docket no. 3898/1202, filed Oct. 25, 2019, the entire contents of which are hereby incorporated by reference herein, for all purposes.

### BACKGROUND

### Technical Field

The present invention relates to LiDAR (light detection and ranging) systems and, more particularly, to LiDAR systems that dynamically varying their temporal scanning patterns to improve frame rate and accuracy.

### Related Art

In general, more laser power and/or longer dwell times are required to acquire reliable, accurate range measurements using LiDAR systems at long ranges than at short ranges. In the simplest case, the amount of signal that returns to a LIDAR system falls off as 1/D², where D is the distance between the LiDAR system and a target. Therefore, conventional LiDAR systems use power levels and dwell times calculated to meet design reliability and accuracy requirements based on maximum distances to objects in fields of view of the systems. However, long dwell times limit revisit frequency and, therefore, how quickly a LiDAR system can detect a new object or a new location of a moved object. Furthermore, power, volume and mass limitations of miniature LiDAR system, such as those used in automotive applications, are often strained by the maximum distance requirements. Smaller, lighter-weight and more power-efficient LiDAR systems are, therefore, desirable.

### SUMMARY OF EMBODIMENTS

An embodiment of the present invention provides a LiDAR system. The LiDAR system has a field of view. The LiDAR system includes a laser, an array of optical emitters and an objective lens. The objective lens optically couples each optical emitter of the array of optical emitters to a respective unique portion of the field of view. An optical switching network is coupled between the laser and the array of optical emitters. A controller is coupled to the optical switching network. The controller is configured to cause the optical switching network to route light from the laser to a sequence of optical emitters of the array of optical emitters according to a dynamically varying temporal pattern. The controller is configured to vary the temporal pattern based at least in part on distance to an object within the field of view. An optical receiver is coupled to the optical switching network. The optical receiver is configured to receive light reflected from the field of view.

Optionally, in any embodiment, the controller may be configured to dynamically vary the temporal pattern based at least in part on reflectivity of the object.

Optionally, in any embodiment, the controller may be configured to dynamically vary the temporal pattern so as to dynamically vary a per-pixel dwell time.

Optionally, in any embodiment, the controller may be configured to repeatedly interrogate a pixel that includes the object during a series of interrogations, without interrupting the series of interrogations to interrogate another pixel. For each interrogation of the series of interrogations, the controller may be configured to automatically estimate a respective distance to the object. The controller may be configured to automatically calculate a respective confidence score of the respective distance. When the confidence score exceeds a predetermined value, the controller may be configured to terminate the series of interrogations and advance to interrogate another pixel.

Optionally, in any embodiment, the controller may be configured to scan different portions of the field of view at different rates.

Optionally, in any embodiment, the controller may be configured to dynamically vary the temporal pattern differently for respective different non-overlapping regions of the field of view.

### BRIEF DESCRIPTION OF THE DRAWINGS

The invention will be more fully understood by referring to the following Detailed Description of Specific Embodiments in conjunction with the Drawings, of which:

FIG. 1 is an overview diagram of a LiDAR system that includes a photonic integrated circuit (PIC), according to an embodiment of the present invention.

FIG. 2 is a diagram of a serpentine waveguide arrangement for a PIC that may be used in the LiDAR system of FIG. 1, according to another embodiment of the present invention.

FIG. 3 is a diagram illustrating multiple laser/detector combinations, each addressing separate portions of a LIDAR system field of view (FOV), according to an embodiment of the present invention.

FIG. 4 is a graph illustrating results of a Monte Carlo simulation of ranging success rate for a pulse encoding scheme, according to an embodiment of the present invention.

FIG. 5A illustrates a multi-laser LiDAR system that scans all its spots in unison, according to the prior art.

FIG. 5B illustrates a multi-laser LiDAR system that scans its spots independently, according to an embodiment of the present invention.

FIG. 6 illustrates a scene containing distant objects and closer objects scanned by a LiDAR system using different dwell times, according to an embodiment of the present invention.

FIG. 7 highlights areas of a scene that should be scanned more frequently by a LiDAR system, according to an embodiment of the present invention.

FIG. 8 illustrates how sky can be more efficiently scanned by a LIDAR system configured for adaptive scanning, according to an embodiment of the present invention.

FIGS. 9A-9D illustrate several configurations of waveguides and MEMS switches for a LIDAR system, according to respective embodiments of the present invention.

FIGS. 10A and 10B show methods for simple control of switches, while providing varying degrees of beam separation, according to respective embodiments of the present invention.

### DETAILED DESCRIPTION OF SPECIFIC EMBODIMENTS

LiDAR systems according to the embodiments of the present invention employ adaptive scanning techniques to minimize laser power required, maximize frame rate achievable while scanning a scene, and improve safety, i.e., utility and effectiveness of the LiDAR system at detecting and ranging. In this context, “safety” refers to being able to safely operate a vehicle or other system based on information from the LiDAR system, for example remaining on course and avoiding collisions. Unless otherwise indicated, safety does not refer to eye safety, as related to possible eye injury by laser light.

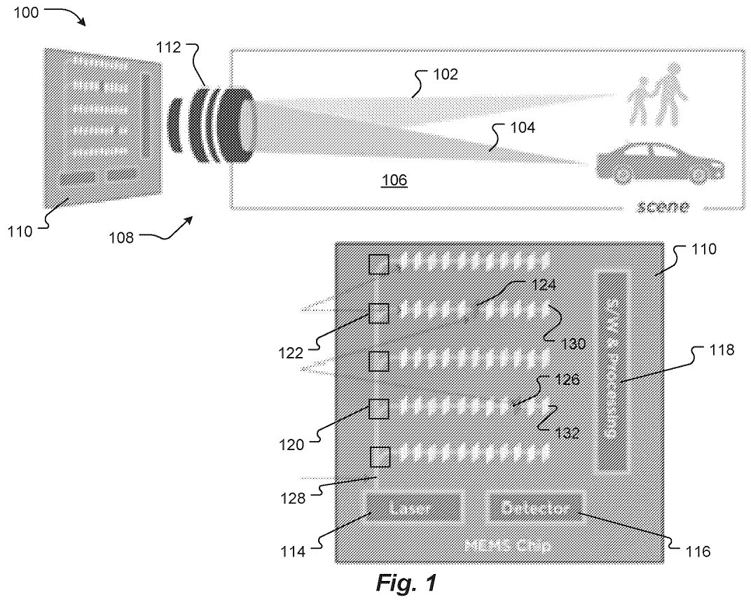

As shown in FIG. 1, a LIDAR system 100, according to embodiments of the present invention, can be configured to emit one or more laser light beams, exemplified by beams 102 and 104, to scan a scene 106 within a field of view of the LiDAR system 100. The LiDAR system 100 includes an optical circuit 108. The optical circuit 108 includes a photonic integrated circuit (PIC) 110, a lens 112, one or more lasers 114, one or more optical detectors 116 and control electronics (a controller) 118.

Light from the laser 114 is coupled into the photonic integrated circuit 110, where a series of two or more optical switches, represented by optical switches 120, 122, 124 and 126, define where on the PIC 110 the light is emitted into free space. In one arrangement, each optical switch 120-122 is a MEMS switch, which may include a MEMS switchable overpass waveguide that couples light from a bus waveguide 128 to a selected waveguide (row), exemplified by rows 130 and 132, of grating switches, exemplified by grating switches 124 and 126.

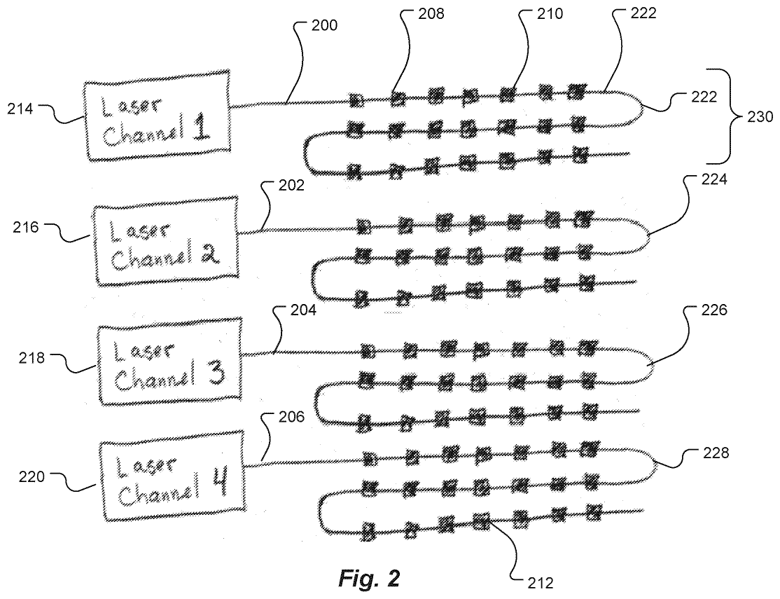

Alternatively, as shown schematically in FIG. 2, each row, exemplified by rows 200, 202, 204 and 206, of grating switches, exemplified by grating switches 208, 210 and 212, is optically coupled to its own laser and detector, represented by laser channels 214, 216, 218 and 220, or by using serpentine waveguides 222, 224, 226 and 228 to feed a multitude of rows, for example rows 230, with multiple grating switches, for example grating switches 208-210, per row. Other alternate switching mechanisms are possible, such as tree switches realized through Mach-Zehnder interferometers. Within each row 200-206, each MEMS switch 208-212 moves a grating in proximity to the waveguide 222-228 to couple light out into free space.

Returning to FIG. 1, the objective lens 112 then directs the light, from the PIC 110, to a specific point or region in the scene 106, based on where on the PIC 110 the light is emitted, i.e, which optical switch 124-126 is ON and therefore couples the light into free space. The point or region can be through of as a pixel of the LIDAR field of view. Reflected light from the scene 106 is collected by the objective lens 112 and coupled back onto the PIC 110. The signal is then coupled from the PIC 110 into the detector 116 and processed by the controller 118. This system 100 is categorized as monostatic, because the same optics, for example the lens 112 and the optical switches 120-126, are used to send the excitation pulse into the scene and collect the return signal.

The PIC 110 and other aspects of the optical circuit 108 are described in U.S. Pat. Publ. No. 2018/0175961, published Jun. 21, 2018, titled “Integrated MEMS Switches for Selectively Coupling Light in and out of a Waveguide,” and U.S. Pat. No. 10,466,423, issued Nov. 5, 2019, titled “Integrated MEMS Switches for Selectively Coupling Light in and out of a Waveguide,” the entire contents of each of which are hereby incorporated by reference herein, for all purposes.

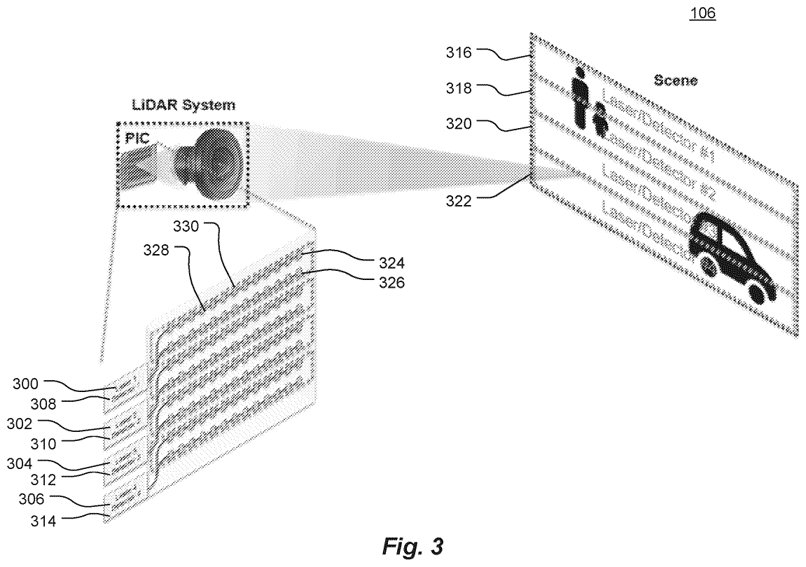

A single laser 114 and detector 116 can be used to address the entire field of view as shown in FIG. 1 or, as shown schematically in FIG. 3, multiple lasers, exemplified by lasers 300, 302, 304 and 306, and multiple detectors, exemplified by detectors 308, 310, 312 and 314, can be used. In this embodiment, each laser 300-306 and detector 308-314 pair addresses a distinct horizontal band, represented by respective bands 316, 318, 320 and 322, within the full field of view. Each laser 300-306 and detector 308-314 has its own set of MEMS switches, which scan the beam across the scene. Using a single laser and detector (FIG. 1) has the advantage of reducing system size, weight, and cost. Using multiple lasers and detectors (FIG. 3) has the advantage of being able to scan a larger number of points (pixels) within the scene 106 per unit of time.

Alternatively, the PIC 110 and objective lens 112 combination can be used together with one or more lasers to scan the beam in the scene, and a separate module (e.g. a separate detector array, not shown) can be configured to collect the return signal. Such as system is categorized as bistatic.

In most cases, a LIDAR system designed to operate at long range is configured to make use of a pulse encoding scheme. This is necessary because at long range, very high pulse energy is required to ensure at least one detected photon returns per pulse. Few lasers are available that can produce these necessary pulse energies, and high pulse energies raise laser eye safety concerns. A work-around is to use a lower pulse energy and send out a high rate pulse train with varying time between pulses, for example random time between pulses or a chirp from some minimum to some maximum pulse frequency. Each spot in the scene is exposed to a number of pulses, and the range is determined by the timing of multiple returns. The ranging success rate, i.e., probability of measuring the correct range to a spot in the scene 106, is determined by the number of detected return photons per pulse and number of pulses sent to each spot.

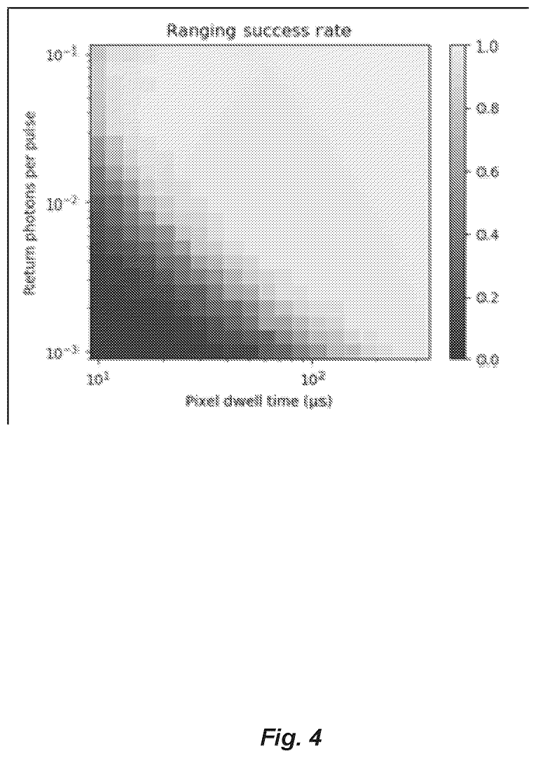

FIG. 4 is a graph illustrating results of a Monte Carlo simulation of ranging success rate for a pulse encoding scheme. A pulse rate is chirped with an average frequency of 60 MHz. From pixel to pixel, the scan may be in a different vertical place in the graph of FIG. 4. For example, after 5-10 pulses or 20-80 psec, the scan may move on to another pixel.

In general, LiDAR systems do not rely on a single pulse reflection to measure distance to an object. Instead, several pulse reflections from the same direction are used to calculate the distance. Some of the pulse reflections may be discarded, for example if the reflected signal level is below a predetermined value, or if the signal-to-noise ratio of the received signal is below a predetermined value.

### How the System Enables Selective Scanning of the Scene

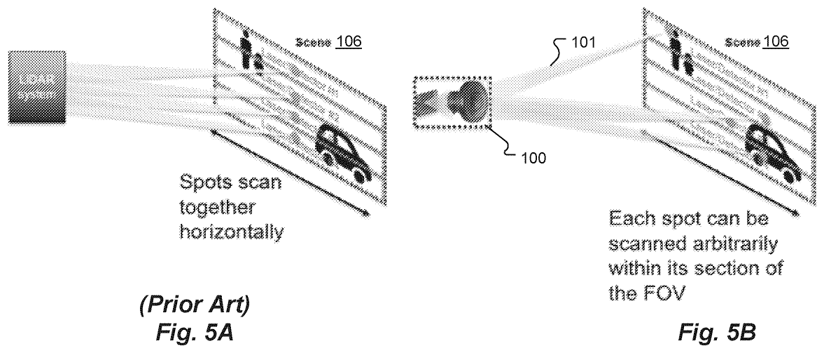

As discussed with respect to FIG. 1, only two MEMS switches are required to select an emission location from any of the gratings 124-126 on the PIC 110. This means that at any point in time, a beam 102 or 104 can be sent to any arbitrary position within the LiDAR system's field of view, allowing a degree of “random access” measurement of pixels, analogous to “random access memory” in computers. If the LiDAR system 100 has multiple detectors 116 or 308-314 and lasers 114 or 300-306 (FIG. 1 or 3) (or multiple laser/detector channels 214-220, FIG. 2), each detector and laser addresses one portion of the PIC and enables scanning of a portion 316-322 of the field of view (FIG. 3). Each laser/detector may be integrated with its own set of MEMS switches 120-126, which can be configured to independently scan arbitrary points within the respective section 316-322 of the field of view. This is in contrast to some other multi-beam LiDAR systems, a representative example of which is shown in FIG. 5A, which are configured with a column of lasers and detectors on a mechanically-actuated chassis, which sweep out the full field of view together, i.e., with synchronized movements. In these prior art examples, individual lasers cannot be selectively scanned across a different horizontal position from other beams. On the other hand, embodiments of the present invention, exemplified in FIG. 5B, scan each spot separately.

### Adaptive Per-Pixel Dwell Time for Improved Frame Rate

The minimum frame rate of a LIDAR system is determined by situations where all or a large portion of the scene 106 is at, or past, the maximum operating range of the LiDAR system, and objects have low reflectivity. The laser power and dwell time per pixel (or spot in the scene) are determined such that a minimum ranging success rate (accurate measurement of the range to a given spot in the scene) is attained at maximum range and low reflectivity. For example, assume that autonomous driving requires at least 50% ranging success per pixel measurement. Then from FIG. 4 we see that a 100 us dwell time per spot is required, assuming 0.001 detected return photons per pulse for a maximum-range, minimum-reflectivity object.

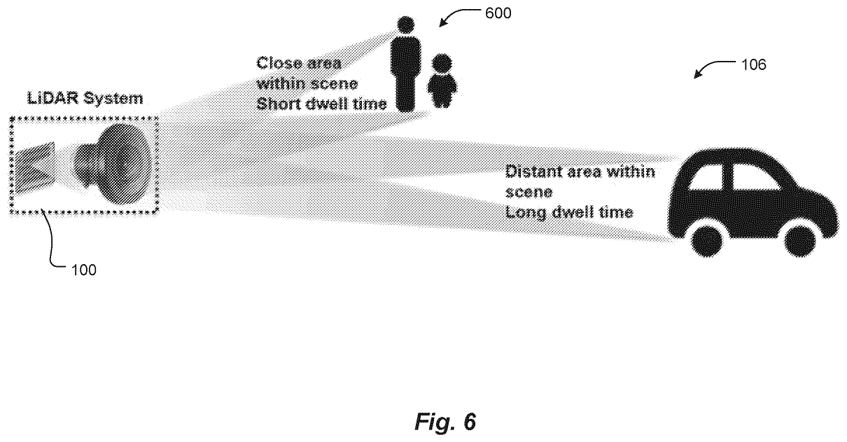

However, because large portions, for example portion 600, of the scene 106 are closer than the maximum range, and some objects have higher reflectivity, a 100 us dwell time is not required at all points within the scene, as illustrated in FIG. 6. The required dwell time for an accurate range measurement is inversely proportional to the number of return photons (FIG. 4). A 2× improvement in signal results in half the required dwell time. By using a short dwell time for close and high-reflectivity objects in the scene 106, the total frame rate of the LiDAR system 100 can be increased.

This adaptive per-pixel dwell time technique makes use of the unique MEMS scanning architecture described herein. As soon as an accurate range measurement is attained from a point in the scene 106, the laser/detector pair in question 114 and 116 or 214-220 or 300-314 (FIGS. 1-3) can shift to the next point in its scan pattern. Because each laser/detector can be scanned independently by the MEMS architecture, adaptive per-pixel dwell time does not require all lasers/detectors to step through their scan pattern in synchrony with one another.

### Improved Safety Using Adaptive Scanning

Prior knowledge of a scene 106 can be used to optimize the scan patterns and improve safety afforded by a LiDAR system 100. Once a complete scan of the full field of view is done, knowledge of the objects within the scene 106 can be used to determine where a higher frame rate is necessary and where a lower frame rate and/or lower resolution would suffice. In general, a full raster scan is wasteful, because areas known, or highly likely, not to contain objects of interest, or that contain objects of low interest, for example because the objects are not humans or do not move, need not be fully scanned and/or need not be scanned as frequently. Thus, for example, since significant objects are not likely to enter the field of view from the sky, if the boundary of the sky can be identified, the interior of the sky boundary need not be scanned at all, or at least much less frequently than other portions of the field of view. This scheme provides more time to scan more relevant portions of the field of view, such as moving vehicles and/or pedestrians.

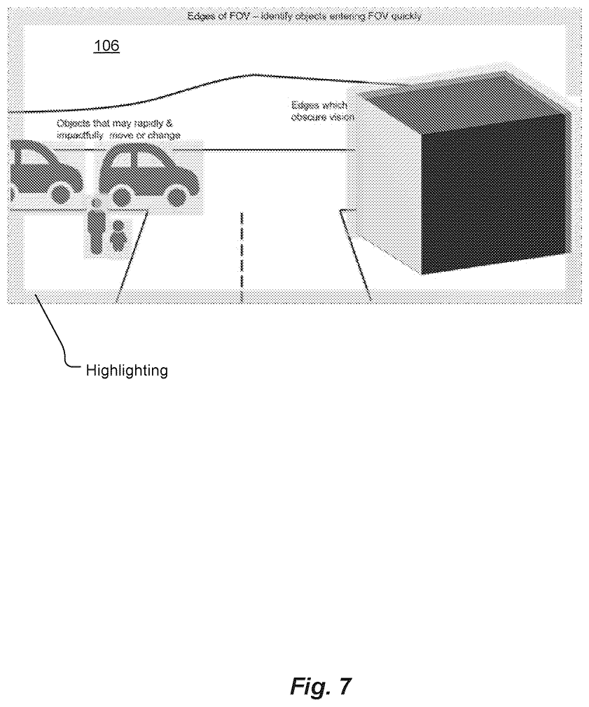

In some situations it may be desirable to have faster refresh rates in specific locations within the scene 106. FIG. 7 highlights areas of a scene 106 that should be scanned more frequently. For example, on city streets with limited visibility around buildings, higher frame rates near corners of buildings would be beneficial to pick up new moving objects, e.g. people, cars, etc., entering the scene 106. The edges of the field of view can also be scanned more frequently to ensure new objects entering the LiDAR system's field of view are identified quickly. Additionally, higher refresh rates can be beneficial to keep track of objects that may rapidly and impactfully move or change, e.g. moving people, bicyclists, cars, car doors that may suddenly swing open, etc. These higher refresh rates can be achieved by using the selective scanning methods to monitor specific areas of interest within the field of view more frequently than the rest of the scene 106, as indicated by highlighted areas in FIG. 7.

“High frequency” objects include any objects that are moving or changing rapidly as a function of time in the scene 106, e.g., people, bicycles, cars. Edges of large objects, such as buildings, around which new objects can enter the scene 106 can also be scanned more frequently to ensure that new objects entering the scene are captured and identified quickly. Scanning the edges of the field of view more frequently also ensures that new objects entering the scene 106 in these areas are identified quickly.

Refreshing some regions within the scene 106 more frequently requires a trade-off of lower refresh rates and/or resolution in other regions within the scene 106. Regions which can be refreshed less frequently include objects that are stationary, e.g. buildings, trees, empty road surface, etc., and objects whose location and behavior is less important, e.g. cars on the opposite side of a highway divided by guardrails. By refreshing stationary and less-important objects less often, such as areas not highlighted in FIG. 7, more time can be spent refreshing portions of the scene 106 that contain objects of interest, as outlined in herein.

Lower scan resolution may be reasonable to use on some objects in the scene. Large objects (e.g. buildings, empty road surface, and large vehicle trailers, etc.) can be scanned at lower resolution if one contiguous object has been identified (areas not highlighted in Error! Reference source not found.). The edges of the object could still be scanned at the full resolution of the LiDAR system, with lower resolution used for the interior of the object in order to spend less time for each frame.

In many situations, the sky can represent a significant portion of the field of view. Because there will be no return signal from the sky, aside from scattered light off aerosols, fog, precipitation, etc., the maximum set dwell time will likely be necessary to ensure safety of the system, i.e., ensure the LiDAR system detects objects in the field of view. This represents a significant load on the LiDAR system, in terms of scan time. However, once the region of the field of view that encompasses the sky is identified, this knowledge can be used to lower the amount of time spent scanning the entirety of the sky. Objects are most likely to enter regions of sky across the edges of the LiDAR system's field of view or at interfaces between sky and foreground objects. Adaptive scanning can be used to selectively scan these areas at the full LiDAR system resolution and higher refresh rate. This will ensure that new objects in the scene 106 are identified quickly, so that the rest of the sky can be scanned at lower refresh rate and/or resolution.

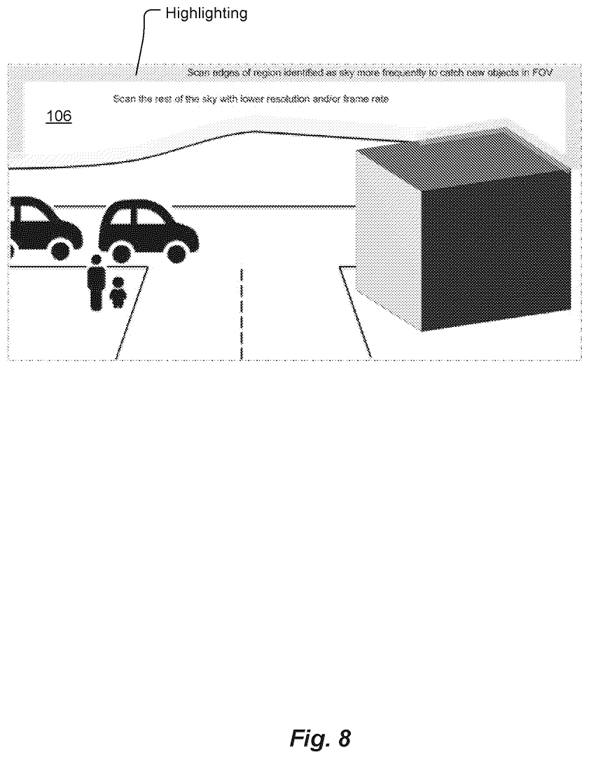

FIG. 8 illustrates how the sky can be more efficiently scanned by a LiDAR system 100 configured for adaptive scanning. The edges of the region identified as sky can be scanned more frequently and at high resolution to identify new objects entering the scene 106. The rest of the sky can be scanned at lower resolution and frame rate to improve the overall frame rate of the entire scene 106.

For improved safety, the low-priority areas of the field of view should still be scanned at full resolution periodically, but they can be scanned at a lower rate than the high-priority areas.

### MOEMS System Architecture Design to Facilitate Better Control of Scan Rates Across the Full Field of View:

Arrangement of the micro-opto-electro-mechanical systems (MOEMS) architecture described in Error! Reference source not found.ig. 1 can be designed such that better control of beam scanning can be achieved in a multi-beam LiDAR system 100. As shown in FIG. 3, in one configuration of the waveguides and MEMS switches, each laser 300-306 and detector 308-314 addresses a contiguous set of horizontal waveguides (a plurality of horizontal waveguides), exemplified by waveguides 324 and 326, with grating couplers, exemplified by grating couplers 328 and 330, distributed along each of the horizontal waveguides 324-326. Each laser 300-306 and detector 308-314 addresses at least one row 324-326 of grating couplers 328-330. In this situation, the adaptive scanning techniques described herein are unlikely to be optimized across the full field of view. In many environments, areas within the lower portions of the field of view, such as horizontal band 322 and perhaps horizontal band 320, are more likely to be close to the LiDAR system 100, whereas areas toward the top of the field of view, such as horizontal bands 316-318, are more likely to be far away from the LiDAR system 100.

An optimized arrangement of the MOEMS architecture would ensure that each laser 300-306 and detector 308-314 in the LiDAR system 100 addresses a section of the field of view that includes some regions that are close to the LIDAR system 100 and some regions that are far from the LiDAR system 100. This can be achieved in a number of ways. For example, waveguides can be arranged vertically, or waveguides addressed by different detectors 308-314 and lasers 300-306 can be interleaved with one another. In some configurations, this can be accomplished with waveguides and MEMS grating switches in a serpentine configuration, for example as illustrated in FIG. 2. In other example configurations, the MEMS overpass waveguide switches can be utilized to ensure that the same laser and detector can address regions within the field of view that are separated from one another.

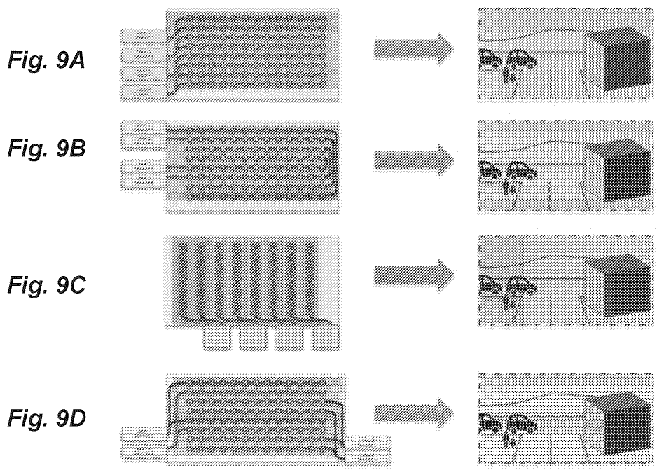

FIGS. 9A-9D illustrate several configurations of waveguides and MEMS switches. In each example, the colors (shadings/hatchings) represent how a specific region of the PIC corresponds to a particular portion of the field of view. In FIG. 9A, the top row likely mostly scans regions of sky in some scenes 106, resulting in low frame rates. In FIGS. 9B, 9C and 9D, different configurations lead to a more equal split between regions within the scene 106 that are close and far from the LiDAR system 100. Adaptive scanning may more effectively lead to an overall high frame rate scanning the entire scene 106 by balancing regions that require high versus low resolution and high versus low refresh rates. All examples, except for FIG. 9D, can readily be reconfigured to use serpentine waveguides with no MEMS overpass waveguide switches. Inclusion of overpass waveguide switches or serpentine waveguides in FIG. 9B can enable each laser and detector to address more than two rows of MEMS grating switches.

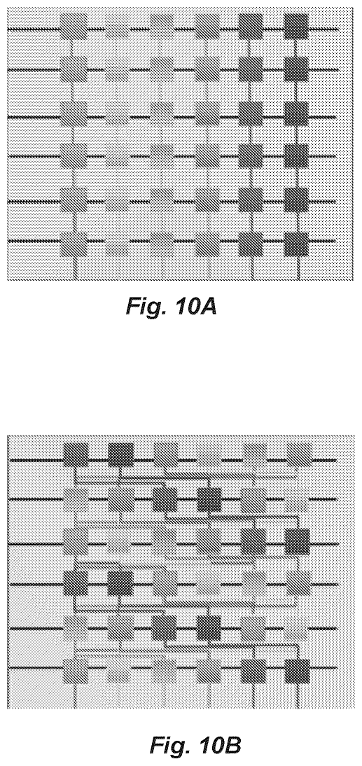

A suitable circuit to control the various configurations shown in FIGS. 2 and 9A-9D is described, with reference to FIGS. 10A and 10B. For many embodiments of the present invention, the beam is switched with random access. FIGS. 10A and 10B show methods for simple control of switches, while providing varying degrees of beam separation. In FIG. 10A, the simple method of connecting all vertical switches together provides poor separation of the beams. But in FIG. 10B, the switches are connected in a way that separates commonly controlled switches by greater spacings.

It is also possible to use a predetermined pattern to obtain better separation between the beam spots. FIGS. 10A and 10B show a comparison between a vertical pattern and more random one. In this example, each switch of the same color (shade/hatch) is controlled by a single wire, and all of the beams with the same color (shade/hatch) therefore switch simultaneously. The colors (shades/hatchings) in the left portion of the drawings correlate to portions of the scene 106 shown in the right portion of the drawings.

The pattern in FIG. 10A is a basic pattern where all the switches in a column are controlled simultaneously. As discussed previously, this provides poor separation between beams. The pattern in FIG. 10B has elements of the same color (shade/hatch) separated from one another in both the horizontal and vertical directions. This requires slightly more complex wiring, but provides a simple method of controlling multiple beams and obtaining greater separation than the vertical case. This is a simple example, and the principle can be expanded for larger arrays and more complicated patterns.

While the invention is described through the above-described exemplary embodiments, modifications to, and variations of, the illustrated embodiments may be made without departing from the inventive concepts disclosed herein. For example, although specific parameter values, such as dimensions and materials, may be recited in relation to disclosed embodiments, within the scope of the invention, the values of all parameters may vary over wide ranges to suit different applications. Unless otherwise indicated in context, or would be understood by one of ordinary skill in the art, terms such as “about” mean within +20%.

As used herein, including in the claims, the term “and/or,” used in connection with a list of items, means one or more of the items in the list, i.e., at least one of the items in the list, but not necessarily all the items in the list. As used herein, including in the claims, the term “or,” used in connection with a list of items, means one or more of the items in the list, i.e., at least one of the items in the list, but not necessarily all the items in the list. “Or” does not mean “exclusive or.”

Although aspects of embodiments may be described with reference to flowcharts and/or block diagrams, functions, operations, decisions, etc. of all or a portion of each block, or a combination of blocks, may be combined, separated into separate operations or performed in other orders. References to a “module” are for convenience and not intended to limit its implementation. All or a portion of each block, module or combination thereof may be implemented as computer program instructions (such as software), hardware (such as combinatorial logic, Application Specific Integrated Circuits (ASICs), Field-Programmable Gate Arrays (FPGAs), processor or other hardware), firmware or combinations thereof.

The LiDAR controller, or portions thereof, may be implemented by one or more processors executing, or controlled by, instructions stored in a memory. Each processor may be a general purpose processor, such as a central processing unit (CPU), a graphic processing unit (GPU), digital signal processor (DSP), a special purpose processor, etc., as appropriate, or combination thereof.

The memory may be random access memory (RAM), read-only memory (ROM), flash memory or any other memory, or combination thereof, suitable for storing control software or other instructions and data. Instructions defining the functions of the present invention may be delivered to a processor in many forms, including, but not limited to, information permanently stored on tangible non-transitory non-writable storage media (e.g., read-only memory devices within a computer, such as ROM, or devices readable by a computer I/O attachment, such as CD-ROM or DVD disks), information alterably stored on tangible non-transitory writable storage media (e.g., floppy disks, removable flash memory and hard drives) or information conveyed to a computer through a communication medium, including wired or wireless computer networks. Moreover, while embodiments may be described in connection with various illustrative data structures, systems may be embodied using a variety of data structures.

Disclosed aspects, or portions thereof, may be combined in ways not listed above and/or not explicitly claimed. In addition, embodiments disclosed herein may be suitably practiced, absent any element that is not specifically disclosed herein. Accordingly, the invention should not be viewed as being limited to the disclosed embodiments.

1.-6. (canceled)

7. A control system for an array of optical emitters, configured to:
route light to the array of optical emitters according to a temporal pattern to interrogate portions of a field of view, wherein the temporal pattern comprises:
an order of interrogation for the array of optical emitters; and
a duration defining a period of time for a corresponding optical emitter of the array of optical emitters to interrogate a respective portion of the portions of the field of view;
determine, based on the interrogation, a distance between an object within the field of view and the array of optical emitters; and
update the temporal pattern based on the distance and the object being within one or more of the portions of the field of view.

8. The control system of claim 1, configured to change the duration for the corresponding optical emitter responsive to the determination of the distance.

9. The control system of claim 1, configured to change the order of interrogation for the array of optical emitters responsive to the determination of the distance.

10. The control system of claim 1, wherein the control system is coupled to a laser configured to produce the light.

11. The control system of claim 3, wherein to update the temporal pattern, the control system is configured to change a power level of the laser.

12. The control system of claim 1, wherein to update the temporal pattern, the control system is configured to change a revisit rate.

13. The control system of claim 1, wherein to update the temporal pattern, the control system is configured to change a dwell time per portion for one or more optical emitters.

14. The control system of claim 1, configured to scan a first subset of the portions more frequently than a second subset based on the updated temporal pattern.

15. The control system of claim 1, wherein an objective lens couples the light to the array of optical emitters.

16. The control system of claim 9, comprising a switching network to route the light to an optical emitter of the array of optical emitters.

17. The control system of claim 1, wherein the temporal pattern comprises a first time period between two consecutive pulses of the light from the corresponding optical emitter.

18. The control system of claim 1, wherein the temporal pattern comprises a second time period between an actuation of a first light emitter and an actuation of a second light emitter.

19. The control system of claim 1, wherein each portion of the one or more portions of the field of view corresponds to at least one optical emitter of the array of optical emitters.

20. A method for controlling an array of optical emitters, comprising:
routing, by a controller, light to the array of optical emitters according to a temporal pattern to interrogate portions of a field of view, wherein the temporal pattern comprises:
an order of interrogation for the array of optical emitters; and
a duration defining a period of time for a corresponding optical emitter of the array of optical emitters to interrogate a respective portion of the portions of the field of view;
determining, by the controller, based on the interrogation, a distance between an object within the field of view and the array of optical emitters; and
updating, by the controller, the temporal pattern based on the distance and the object being within one or more of the portions of the field of view.

21. The method of claim 14, wherein updating the temporal pattern comprises changing, by the controller, the duration for the corresponding optical emitter responsive to the determination of the distance.

22. The method of claim 14, wherein updating the temporal pattern comprises changing, by the controller, the order of interrogation for the array of optical emitters responsive to the determination of the distance.

23. The method of claim 14, comprising producing, by a laser, the light.

24. The method of claim 17, wherein updating the temporal pattern comprises changing, by the controller, a power level of the laser.

25. A LiDAR system comprising:
an array of optical emitters; and
a control system configured to:
route light to the array of optical emitters according to a temporal pattern to interrogate portions of a field of view, wherein the temporal pattern comprises:
an order of interrogation for the array of optical emitters; and
a duration defining a period of time for a corresponding optical emitter of the array of optical emitters to interrogate a respective portion of the portions of the field of view;
determine, based on the interrogation, a distance between an object within the field of view and the array of optical emitters; and
update the temporal pattern based on the distance and the object being within one or more of the portions of the field of view.

26. The LiDAR system of claim 19, wherein each portion of the one or more portions of the field of view corresponds to at least one optical emitter of the array of optical emitters.
